(19) United States
(12) Patent Application Publication
(10) Pub. No.: US 2024/0048818 A1
(43) Pub. Date: Feb. 8, 2024

(54) CREATING AND POPULATING RELATED SHORT-FORM VIDEO SEGMENTS

(71) Applicant: Loop Now Technologies, Inc., San Mateo, CA (US)

(72) Inventors: Daniel Scott Rapaport, Redwood City, CA (US); Jerry Ting Kwan Luk, Menlo Park, CA (US); Roger Hirano Mendonca, Cruzeiro (BR); Nicole Leonard, Austin, TX (US)

(73) Assignees: Loop Now Technologies, Inc., San Mateo, CA (US); Loop Now Technologies, Inc., San Mateo, CA (US)

(21) Appl. No.: 18/230,202

(22) Filed: Aug. 4, 2023

Related U.S. Application Data
(60) Provisional application No. 63/524,900, filed on Jul. 4, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/430,372, filed on Dec. 6, 2022.
(60) Provisional application No. 63/424,958, filed on Nov. 14, 2022.
(60) Provisional application No. 63/423,128, filed on Nov. 7, 2022.
(60) Provisional application No. 63/414,604, filed on Oct. 10, 2022.
(60) Provisional application No. 63/413,272, filed on Oct. 5, 2022.
(60) Provisional application No. 63/395,370, filed on Aug. 5, 2022.
(60) Provisional application No. 63/522,205, filed on Jun. 21, 2023.

(51) Int. Cl. H04N 21/81; H04N 21/472; H04N 21/25; H04N 21/234

(52) U.S. Cl. CPC H04N 21/812; H04N 21/472; H04N 21/251; H04N 21/234

(57) ABSTRACT

Disclosed embodiments provide techniques for automated video processing. Short-form videos are analyzed and video segments are created from the short-form videos. A related short-form video can be used to create a new video segment, promoting a short-form video. The new video segment is populated on the website by a floating video player or banner ad providing a link to the related short-form video. Video segments can promote and/or demonstrate a product and/or service. The video segments show and describe various aspects of a product. The video segments are disseminated to one or more websites. The video segments can be shown as video thumbnails, banner advertisements, or rich media advertisements. The video segments can be disseminated based on context, and different segments can be provided to different websites. The different video segments can be disseminated based on demographic information, geographic region, and/or other criteria.

### RELATED APPLICATIONS

This application claims the benefit of U.S. provisional patent applications “Creating And Populating Related Short-Form Video Segments” Ser. No. 63/395,370, filed Aug. 5, 2022, “Object Highlighting In An Ecommerce Short-Form Video” Ser. No. 63/413,272, filed Oct. 5, 2022, “Dynamic Population Of Contextually Relevant Videos In An Ecommerce Environment” Ser. No. 63/414,604, filed Oct. 10, 2022, “Multi-Hosted Livestream In An Open Web Ecommerce Environment” Ser. No. 63/423,128, filed Nov. 7, 2022, “Cluster-Based Dynamic Content With Multi-Dimensional Vectors” Ser. No. 63/424,958, filed Nov. 14, 2022, “Text-Driven AI-Assisted Short-Form Video Creation In An Ecommerce Environment” Ser. No. 63/430,372, filed Dec. 6, 2022, “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, and “Text-Driven Video Editing With Machine Learning” Ser. No. 63/524,900, filed Jul. 4, 2023.

Each of the foregoing applications is hereby incorporated by reference in its entirety.

### FIELD OF ART

This application relates generally to video processing and more particularly to creating and populating related short-form video segments.

### BACKGROUND

From the earliest times recorded, humans have used drawings, pictures, and images to communicate. Wall drawings, paintings, tapestries, murals, photographs, motion pictures, digital videos, and even whole pictorial languages have been used to relate stories, record history, and communicate ideas and feelings in cultures worldwide and across the ages. Combined with written or spoken words, instrumental and vocal music, or used on their own, a picture, in one form or another, truly speaks a thousand words. As our culture has progressed, the sophistication of images and their uses has also advanced. Computers can be used to draw images with colors and textures simultaneously. Still photography has moved from film to digital recording, as have motion pictures. Animation has grown from single-pane cartoons to three-dimensional images nearly indistinguishable from real life. Pieces of art that were once available only in a museum can now be viewed anywhere, at any time, and can be manipulated using software available on a home computer or cell phone. Photographs and videos can be taken and edited on handheld devices relatively quickly. They can be distributed rapidly across the globe just as quickly.

Because of these technological advances, people are able to communicate a message or idea more efficiently. Not only has the time to distribute images shortened, for many of us, the number of images required and the amount of time needed to understand them have also shortened. Just as social media applications have shortened our written language patterns, television commercials and video media platforms have allowed us to communicate with compelling images more rapidly. Over the last decade, social media has grown rapidly in importance. Billions of people actively use social media. Many social media users look up to “influencers” in social media to guide them with their decision making. Influencers in social media are people who have built a reputation for their knowledge and expertise on a specific topic. They make regular posts about that topic on their preferred social media channels and generate large followings of enthusiastic, engaged people who pay close attention to their posts. Brands love social media influencers because they can create trends and encourage their followers to buy products that they promote by way of social media posts of videos and other media types. The advent of short-form video has contributed to the amount of global data on the Internet. As technologies improve and new services are enabled, the amount of global data available, and the rate of consumption of that data, will only continue to increase.

In social media systems, as well as other content sharing systems, video, music, and other types of media files are encoded and transmitted in sequential packets of data so they can be streamed instantaneously. Thus, the term “streaming” can refer to any media content, live or previously recorded, that is delivered to computers and mobile devices via a network communication protocol, and played back in real time. Podcasts, webcasts, movies, TV shows, and music videos are common forms of streaming content. Social media platforms and others broadcast everything from celebrity events, promotions, and livestreaming, to streaming between users. Streaming video can be viewed on a variety of compatible smartphones, tablets, TVs, and/or computer or gaming consoles with a relatively fast internet connection.

### SUMMARY

Modern personal electronic devices, along with the development of the Internet, have enabled easy content creation, as well as efficient distribution of that content. A variety of internet protocols, such as HTTP Live Streaming (HLS), Real-Time Messaging Protocol (RTMP), Web Real-Time Communications (WebRTC), and Secure Reliable Transport (SRT), to name a few, enable unprecedented amounts of video sharing. The videos can include news videos, educational videos, entertainment videos, how-to videos, as well as product discussion videos and/or product promotion videos.

Disclosed embodiments provide techniques for creating videos that promote products and services based on short-form videos. Livestream and livestream replays from a short-form video library are accessed and evaluated by computer-implemented techniques. Product discussions within the short-form videos are detected and edited to form new video segments. The video segments are then displayed as advertisements on one or more relevant websites. When a user selects (e.g., by clicking, tapping, etc.) the displayed advertisement, they may be redirected to a livestream video or livestream replay, and/or presented with other information pertaining to a product or service that is the subject of the video segment. In this way, video processing is performed using automated methods to create compelling content for product promotion and dissemination of related information.

A computer-implemented method for video processing is disclosed comprising: receiving, from a website, a request for video content, wherein the request includes context data; accessing, from a server, a library of short-form videos; searching the library of short-form videos for a related short-form video, wherein the searching is based on the context data; creating a new video segment based on the related short-form video; and populating the new video segment in the website, wherein the populating provides a link to the related short-form video. In embodiments, the populating of the new video segment partially overlays a video playing on the website. In embodiments, the new video segment promotes the related short-form video. In embodiments, the new video segment is a portion of the related short-form video. In embodiments, the new video segment is selected based on an engagement score for a plurality of portions of the related short-form video. In embodiments, a second new video segment is simulcast to a second user simultaneously with the new video segment being shown to a first user. And in embodiments, the library includes metadata associated with the related short-form video. Some embodiments include a computer program product embodied in a non-transitory computer readable medium for video processing, the computer program product comprising code which causes one or more processors to perform operations of: receiving, from a website, a request for video content, wherein the request includes context data; accessing, from a server, a library of short-form videos; searching the library of short-form videos for a related short-form video, wherein the searching is based on the context data; creating a new video segment based on the related short-form video; and populating the new video segment in the website, wherein the populating provides a link to the related short-form video.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for creating and populating related short-form video segments.

FIG. 2 is a flow diagram for enabling related short-form video editing and overlays.

FIG. 3 is an infographic for creating and populating related short-form video segments.

FIG. 4 is a block diagram for searching for related videos.

FIG. 5 is an example advertisement overlay on a webpage.

FIG. 6 is an example of editing related short-form videos with specified time intervals from highlighted image.

FIG. 7 is an example of editing related short-form videos with specified time intervals with speech recognition.

FIG. 8 is a system diagram for creating and populating related short-form video segments.

### DETAILED DESCRIPTION

Techniques for automated video processing are disclosed. Short-form videos are analyzed and video segments are created from the short-form videos. The video segments can promote and/or demonstrate a product and/or service. The video segments can show and describe various aspects of a product. The video segments are then disseminated to one or more websites as advertisements. The video segments can be shown as video thumbnails, banner advertisements, and/or rich media advertisements. The video segments can be disseminated based on context. Different video segments pertaining to the same product can be disseminated to different websites. The different video segments can be disseminated based on demographic information, geographic region, and/or other criteria.

The video segments are created via automated computer-implemented techniques. These techniques can include, but are not limited to, speech recognition, computerized object recognition, natural language processing, and/or machine learning processes. The video segments can be processed based on facial recognition. The facial recognition can include identifying a celebrity in a short-form video. The dissemination of the video segment can be based on the identified celebrity. These and other features of disclosed embodiments improve the technical field of video processing.

The Internet and social media play a major role in helping consumers find desired products and services. Using platforms like Facebook®, Twitter® and YouTube®, consumers are able to comment on their experiences with products and companies and share them with their friends. This has led to the growing need for companies to generate positive customer experiences in order to minimize negative word-of-mouth messages, which are easily spread within the social media platforms to additional potential customers.

Product and/or service providers can use influencer marketing to establish credibility in the market, create “buzz” around their brand, and/or promote online or in-store sales of their products. Therefore, influencer marketing can be incredibly important for product and service providers. Thus, companies expend great effort in order to try to retain a strong presence in social media platforms. Disclosed embodiments provide video processing techniques that automate and simplify the dissemination of influencer content. Influencer content, which can be in a format such as a livestream or livestream replay, can be automatically analyzed to find an appropriate excerpt, edit the excerpt, and convert it to a new video segment that gets distributed to related sites as advertisements in various formats. Thus, disclosed embodiments unlock product promotion opportunities and content creator monetization opportunities that heretofore did not exist.

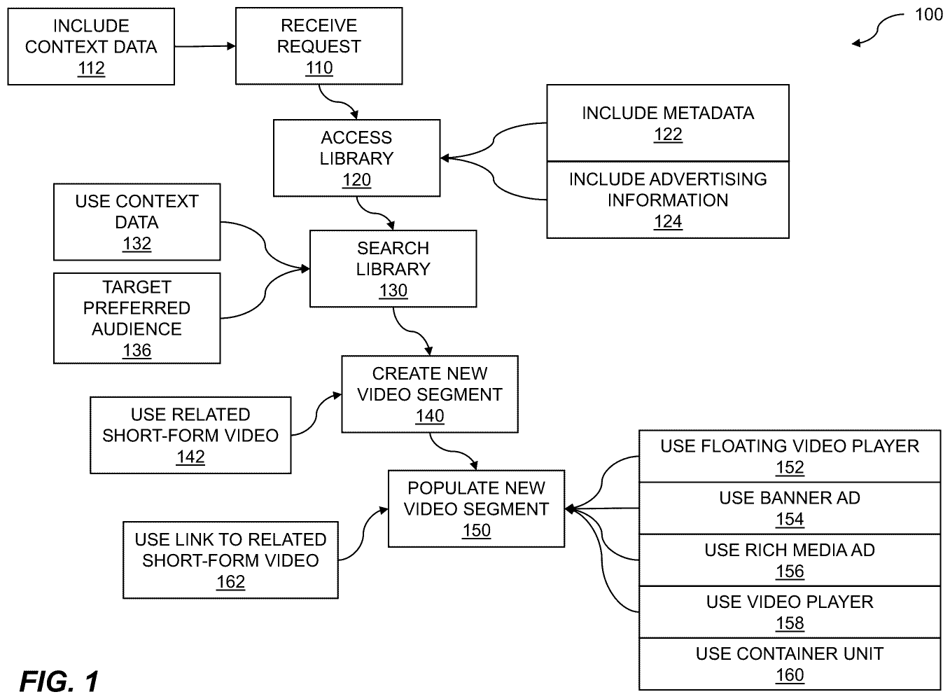

FIG. 1 is a flow diagram 100 for creating and populating related short-form video segments. The flow includes receiving a request 110 for video content from a website. The request can include context data 112. The context data can include a product category, a product brand name, a preferred audience, and/or other information. The context data can include website views, links, advertising history, domain information, user history, conversion rates, or ranking. The flow includes accessing a library 120 of short-form videos. The flow can include accessing metadata 122 pertaining to the short-form videos. The metadata can include a creation date, geographic location, title, subject, host individual information, video resolution, video format, language, and/or other relevant information. In embodiments, the library includes metadata associated with the related short-form video. In some embodiments, the metadata associated with the related short-form video includes hashtags, repost velocity, user attributes, user history, ranking, product purchase history, view history, or user actions. The flow can include advertising information 124. The advertising information can include a list of products; a duration and time period for when each product is discussed in a video; a type of discussion, such as a demonstration or product review; and the like. In embodiments, the library includes advertising information. In embodiments, the advertising information includes a listing of related products, a listing of related product categories, closed-captioned text, or host information associated with the related short-form video.

The flow includes searching the short-form video library 130. The flow can include using context data 132 as criteria for searching the short-form video library. In embodiments, the context data includes website views, links, advertising history, domain information, user history, conversion rates, or ranking. The flow can include targeting a preferred audience 136. Thus, in embodiments, the searching further comprises targeting a preferred audience. In embodiments, the targeting is based on celebrity participation in the related short-form video. In some embodiments, the targeting is based on user geographic region, time of day, related websites, or demographic information. As an example, a targeted audience for an advertisement for a toy can be youth or young adults. Additionally, another targeted audience for an advertisement for the toy can be parents of youths (e.g., adults with an age range of 35-50 years old).

The flow includes creating a new video segment 140. The new video segment 140 can include a portion of a short-form video. Thus, the flow can include using a related short-form video 142 for the creation of the new video segment. In embodiments, the related short-form video is a livestream or livestream replay. In some embodiments, the new video segment may have a playing duration ranging from two seconds to 100 seconds. In some embodiments, the new video segment may have a playing duration ranging from five seconds to 30 seconds. The flow includes populating the new video segment 150. The populating of the new video segment deploys the new video segment as an advertisement on one or more related websites. In embodiments, the populating of the new video segment is accomplished by a floating video player 152, banner ad 154, rich media ad format 156, or video player 158. The populating of the new video segment can also be accomplished by container unit 160. The container unit can include a carousel frame widget, story block frame widget, grid frame widget, and so on. A floating video player can be a video player widget that is rendered on top of an existing webpage. In some embodiments, the floating video player is moveable and/or resizable by a viewer. Banner advertisements can be digital advertisements displayed in the header, footer, sidebars, or elsewhere within websites. Banner advertisements can be clickable digital ads that are embedded into websites to drive traffic to the website of the advertiser. A rich media advertisement can include advanced features like video, audio, or other elements that encourage viewers to interact and engage with the content. Video players can be static displays that play one or more videos in the website. A carousel frame widget is a container unit which can display at least two short-form videos and can include borders separating the videos. The carousel frame widget borders can have different colors, widths, sizes, etc. Additional videos can be displayed by the user by scrolling videos left and right in the widget based on a user action such as a click, tap, etc. A story block widget is a container unit which can display at least one short-form video within the story block frame border. An active video can remain in the front of the story block frame widget while additional videos can have their views partially obstructed. In embodiments, the additional videos can be blurred, obscured, tinted, overlayed, colored, and so on, to show that they remain in the background. The story block frame border can have different colors, widths, sizes, etc. The story block frame widget can allow users to scroll videos left and right so that a new video can be displayed in the front of the story block widget. A grid frame widget is a container unit which can display at least two short-form videos in a grid layout. The grid layout can contain one or more videos in both the x and y directions and can include borders separating the videos. The grid frame widget borders can have different colors, widths, sizes, etc. Thus, disclosed embodiments provide ways to engage and involve the audience to increase brand awareness and generate clicks. In some embodiments, the new video segment plays in a continuous loop. In some embodiments, the new video segment plays in a continuous loop with the sound muted until selected (e.g., clicked on, tapped on, etc.), at which time the new video segment plays with the sound unmuted.

The flow can include using a link to the related short-form video 162 or to another website containing the short-form video. In these embodiments, when a user selects an advertisement with the new video segment (e.g., via a floating video player, banner advertisement, rich media advertisement, video player, and/or container unit), the user is directed to the related short-form video. The related short-form video can be a livestream, livestream replay, or another short-form video. In some embodiments, the user is directed to a specific point within the short-form video. The specific point can include the origin point for the new video segment. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

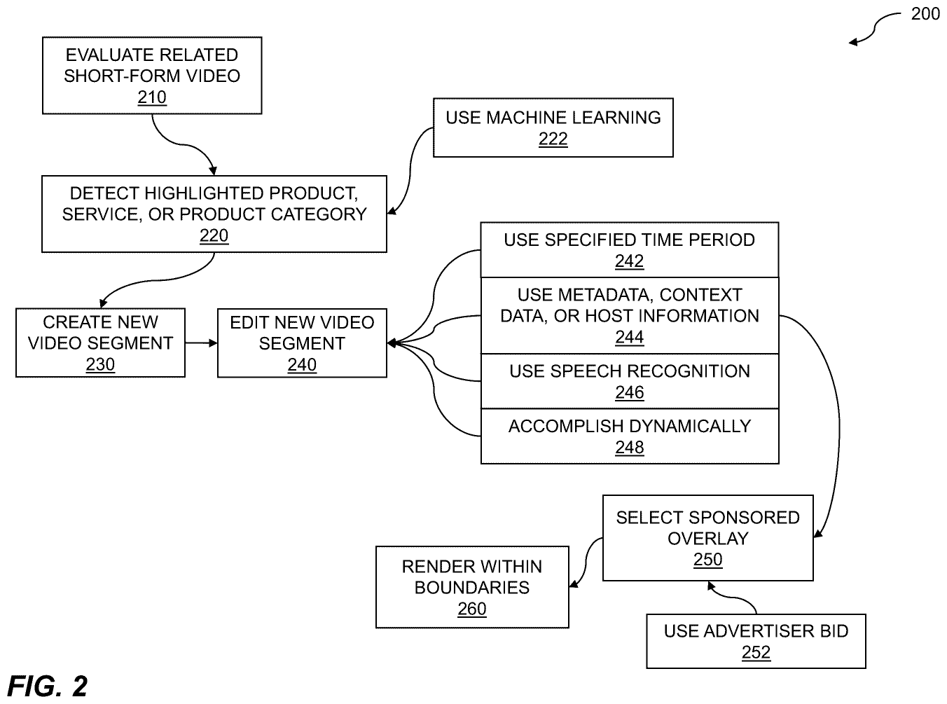

FIG. 2 is a flow diagram 200 for enabling related short-form video editing and overlays. The flow includes evaluating the related short-form video 210. Thus, embodiments can include evaluating the related short-form video. The evaluating of the related short-form video can include performing an engagement score for the short-form video. In embodiments, the evaluating is based on recommendations, likes, closed-captioned text, or user activity on a social media platform. The user activity can include a watch time duration (how long viewers tended to watch the short-form video). The flow includes detecting a highlighted product, service, or product category 220. Thus, embodiments can include detecting that a product, service, or product category related to the context data is highlighted in the related short-form video. In embodiments, the detecting is based on machine learning 222. The machine learning may utilize one or more image classifiers for the detecting. The image classifiers can include, but are not limited to, Haar cascade classifiers, perceptrons, Naïve Bayes classifiers, K-nearest neighbor classifiers (KNNs), Support Vector Machines (SVMs), Random Forests, and/or other suitable image classifiers. The image classifiers can be used to recognize certain objects within a short-form video. For example, the image classifiers can be used to detect shoes within a short-form video. The image classifiers can be used to recognize certain people (e.g., celebrities) within a short-form video. The machine learning can also include audio analysis. The audio analysis can include natural language processing (NLP) techniques. The audio analysis can include speech-to text processing. The converted text can be analyzed by the NLP techniques to perform tasks such as disambiguation and entity detection.

The flow includes creating a new video segment 230. Entity detection can be used to determine a subject or subjects for a short-form video, and to further determine its suitability for use in the creation of a new video segment. In embodiments, the new video segment promotes the related short-form video. Embodiments can include editing the new video segment 240. In embodiments, the editing is based on metadata, context data, or host information. The editing can include muting the associated audio track for the new video segment. The editing can include replacing the associated audio track for the new video segment. The replaced audio track can be of a different spoken language than the original audio track for the new video segment. The editing can include adding visual effects. The editing can include adding audio effects. The editing can be performed using a specified time period 242. The specified time period can be based on when a product was shown and/or spoken about during a short-form video. The editing can be performed using metadata, context data, or host information 244. The host information can include the name of a host individual, such as an influencer or celebrity. The editing can be performed using speech recognition 246. The speech recognition can include utterances from a host individual or other participant within the short-form video. The utterances can be recognized as the name of a product or as other words and/or phrases associated with a product. In embodiments, the new video segment is a portion of the related short-form video. In embodiments, the editing is accomplished dynamically 248. As an example, a livestream video may be broadcast live, and disclosed embodiments can create new video segments on the fly in real time. Embodiments can include selecting, from a sponsor library, a sponsored overlay 250. The sponsored overlay can include a region of a webpage or app user interface that is eligible to be populated with a new video segment. The sponsored overlay can have boundaries associated with it, which correspond to the region of a webpage or app user interface that is eligible to be populated with a new video segment. The new video segment can be based on a related short-form video. In some embodiments, multiple advertisers may bid for an opportunity to place a new video segment on their respective websites, with the highest bid winning the opportunity. Thus, some embodiments may use an advertiser bid 252 for determining the placement of a new video segment. The new video segment may be rendered within boundaries 260. The boundaries can be the boundaries of a display window of an electronic display, or the boundaries of a specified region within a display window on an electronic display.

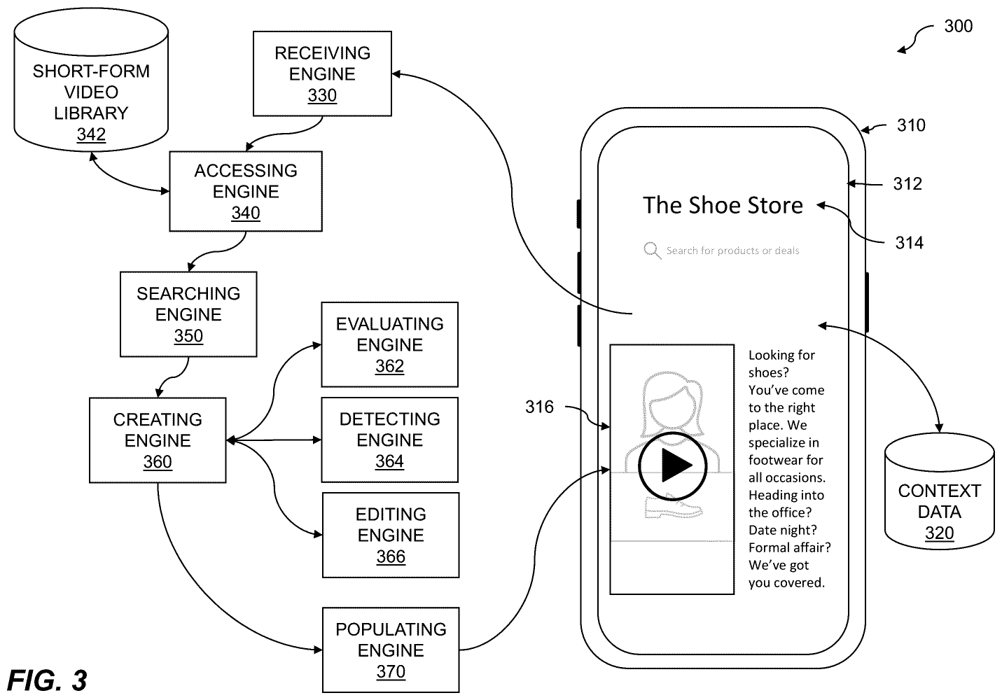

FIG. 3 is an infographic 300 for creating and populating related short-form video segments. A client device 310 has an electronic display 312. The client device can be a mobile device, such as a smartphone or tablet computer. The electronic display displays a webpage 314. In embodiments, the website is an application running on a mobile device. When the webpage is displayed, it causes program instructions to be executed by a processor within the client device 310 that issues a request for a new video segment to be used as an advertisement. The request can be based on context data 320. The context data can include website views, links, advertising history, domain information, user history, currency conversion rates, location information, weather data, and/or ranking. This request is received by a receiving engine 330. The receiving engine 330 may be implemented on a server that exposes APIs to the client device 310. The APIs can include an API such as GetVideoSegment( ). The client device 310 can invoke the GetVideoSegment( ) API when the webpage 314 is launched. This causes a request to be sent to a system for creating and populating related short-form video segments. In response to receiving the request, a short-form video library 342 is accessed via accessing engine 340. The accessing engine 340 may utilize HTTP APIs, RESTful APIs, JSON, and/or other suitable protocols for accessing the short-form video library. A searching engine 350 searches the short-form video library 342 for candidate related short-form videos to use for creation of a new video segment by the creating engine 360. The criteria used by the searching engine 350 can include product criteria, demographic criteria, geographic criteria, and/or other relevant criteria.

As an example, it can be seen that the webpage 314 is a shoe-related website, as the banner for the site reads “The Shoe Store.” In this case, the searching engine 350 may search for short-form videos pertaining to shoes. In some embodiments, the client device 310 may provide location information. As an example, if the client device 310 indicates a location of New York, then the searching engine may further refine the search criteria to search for short-form videos created by content creators in or near New York. As another example, if weather data indicates it is currently snowy, the searching engine 350 may search for short-form videos pertaining to boots or other winter footwear. Other criteria may be used in addition to, or instead of, the search criteria mentioned.

In embodiments, a best candidate related short-form video is obtained, based on output of an evaluating engine 362, and then the creating engine 360 creates a new video segment from the best candidate related short-form video. The new video segment can be a portion of the short-form video. The evaluating engine 362 can utilize various criteria for evaluation, including, but not limited to, likes, closed-captioned text, or user activity on a social media platform.

A detecting engine 364 can utilize object recognition, speech recognition, and/or other techniques to determine a temporal point within a short-form video where a product or service is introduced for discussion and/or demonstration. The detecting engine 364 may identify a timestamp corresponding to a frame or chunk (collection of one or more video frames) of video, where the product or service is introduced for discussion and/or demonstration. That timestamp is then sent to editing engine 366. The editing engine may determine an origin point that precedes the timestamp, and a termination point that comes after the timestamp. The editing engine 366 then sends timestamps corresponding to the origin point and termination point to the creating engine 360, which then creates the new video segment based on the supplied timestamps.

The new video segment is sent to populating engine 370. The populating engine 370 deploys the new video segment to the webpage 314 as a floating video player, shown at 316. The floating video player can be a sponsored overlay. In embodiments, the new video segment is rendered on the website within the boundaries of the sponsored overlay. In embodiments, the populating of the new video segment partially overlays a video playing on the website. In some embodiments, the short-form video may be selected randomly from amongst a plurality of candidate related short-form videos. Continuing with this example using shoes, a plurality of short-form videos related to shoes can be identified by the searching engine 350, and one short-form video from the plurality of short-form videos related to shoes may be selected for use in creating a new video segment that is rendered in the floating video player shown at 316.

Some embodiments may utilize a multistage populating process. The stages can include a first stage including a text field, a second stage including a link field, a third stage including a static thumbnail stage, and a fourth stage including a new video segment. In some embodiments, some stages of the multistage populating process may be skipped. As an example, in a situation where a website makes a request for a new video segment, but no video segments are currently available, the request can initiate the creation of a new video segment, and while waiting for the new video segment to be available, the requesting website may first receive a static thumbnail for display. The static thumbnail can be based on a short-form video. Once a new video segment is available, the static thumbnail is removed and the new video segment plays in the region where the static thumbnail was previously displayed. In some embodiments, when a website makes a request for a new video segment, but no video segments are currently available, the requesting website may first receive a text field. The text field may indicate a status message such as “Content Loading.” Once the new video segment is available, the text field is removed and the new video segment plays in the region where the text previously was displayed. In some embodiments, when a website makes a request for a new video segment, but no video segments are currently available, the requesting website may first receive a link field. The link field may include a link to a related short-form video. Once the new video segment is available, the link field is removed and the new video segment plays in the region where the link was previously displayed. In some embodiments, when a new video segment is not immediately available, it may take a finite amount of time (e.g., one to five seconds) to create the new video segment. While the new video segment is being created by the creating engine, a preceding stage such as a link field and/or static thumbnail can be displayed first, until the new video segment is ready, creating an improved user experience. Thus, by using the multistage populating process, the aforementioned embodiments can enable a more streamlined user experience for viewing and interacting with new video segments.

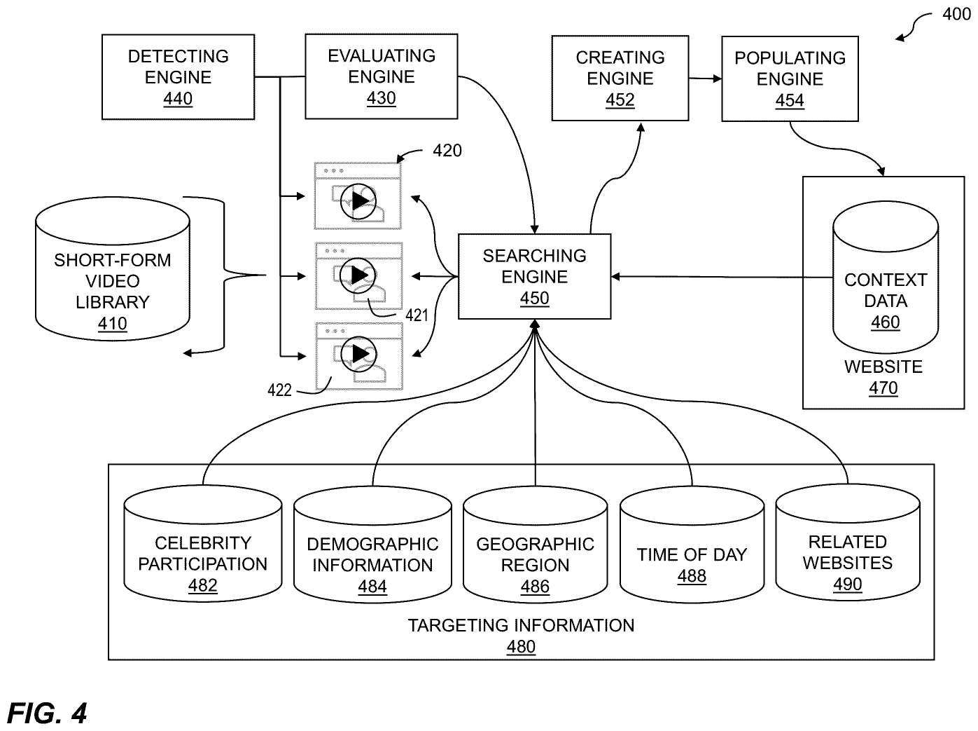

FIG. 4 is a block diagram 400 for searching for related videos. A short-form video library 410 is a repository containing multiple short-form videos. The short-form videos can be livestreams, livestream replays, and/or other types of short-form videos. The short-form videos can include videos created by influencer content creators. The short-form videos can include discussions, demonstrations, and/or promotions of products. In embodiments, the short-form video library utilizes an SQL database for storing metadata pertaining to each video. A searching engine 450 searches the short-form video library 410 utilizing context data 460 provided by website 470. As an example, the context data for a website for an online shoe store may be determined as having a context pertaining to footwear. In embodiments, the context data may be obtained by scraping the website and identifying keywords within text on the website. The context data may also be obtained by performing object recognition on images displayed on the website. As an example, object recognition on images on a shoe website may identify various types of footwear, such as sneakers, boots, high-heeled shoes, etc. The context data is then used by the searching engine 450 to identify one or more short-form videos, indicated as 420, 421, and 422, that are candidates for use in creating a new video segment.

The evaluating engine 430 can utilize various criteria for evaluation, including, but not limited to, likes, closed-captioned text, or user activity on a social media platform, to determine if a short-form video is suitable for use as a basis for creation of a new video segment. The detecting engine 440 can utilize object recognition, speech recognition, and/or other techniques to determine a temporal point within a short-form video where a product or service is introduced for discussion and/or demonstration. The detecting engine 440 may identify a timestamp corresponding to a frame or chunk (collection of one or more video frames) of video where the product or service is introduced for discussion and/or demonstration.

The creating engine 452 creates one or more new video segments based on the selected short-form videos, using the temporal information provided by the detecting engine 440. The populating engine 454 then deploys the new video segment to the website 470. The populating engine can utilize targeting information 480 in determining where to deploy a given new video segment. The targeting information can include celebrity participation 482. In embodiments, facial recognition and/or voice recognition may be used to identify a given celebrity. In embodiments, the populating engine 454 may maintain a database of celebrity metadata. The celebrity metadata can include an age group in which the celebrity is popular. The populating engine 454 may deploy the new video segments to websites based on the celebrity metadata. The targeting information can include demographic information 484. The demographic information can include an age range, income bracket, and/or other demographic information. The populating engine 454 may deploy the new video segments to websites based on the demographic information 484. The targeting information can include geographic region information 486. The geographic region information can include a city, state, country, and/or other geographic region information. The populating engine 454 may deploy the new video segments to websites based on the geographic region information 486. As an example, a new video segment created from a short-form video by a Canadian content creator may be deployed to Canadian websites by the populating engine 454, while a new video segment created from a short-form video by an Australian content creator may be deployed to Australian websites by the populating engine 454. Using the shoe website example shown in FIG. 3, this feature allows Canadian footwear e-commerce websites to receive a Canadian new video segment from the populating engine 454, while Australian footwear e-commerce websites receive an Australian new video segment from the populating engine 454.

The targeting information can include time of day 488. The time of day 488 can include a time specifier, such as morning, afternoon, evening, late night, etc. The populating engine 454 may deploy the new video segments to websites based on the time-of-day information. As an example, the searching engine 450 and/or evaluating engine 430 may select videos appropriate for youth or young adults in an afternoon time of day. The targeting information can include related websites 490. The related websites can include e-commerce websites that sell similar and/or related merchandise as website 470. As an example, if website 470 is an automobile sales website, the related websites 490 can include other automobile sales websites, and/or related sites, such as automobile parts websites, automobile repair websites, and so on. The populating engine 454 may deploy the new video segments to websites based on the related websites 490.

In embodiments, the new video segment is selected based on an engagement score for a plurality of portions of the related short-form video. In embodiments, the selecting is based on detecting that a product, service, or product category related to the context data is highlighted in the related short-form video. In embodiments, a second new video segment is simulcast to a second user simultaneously with the new video segment being shown to a first user. The second user and first user may be viewing the new video segments on different websites. The second user and first user may be of different age ranges. The second user and first user may each be served a different new video segment based on targeting information 480. In embodiments, the selecting is based on context data.

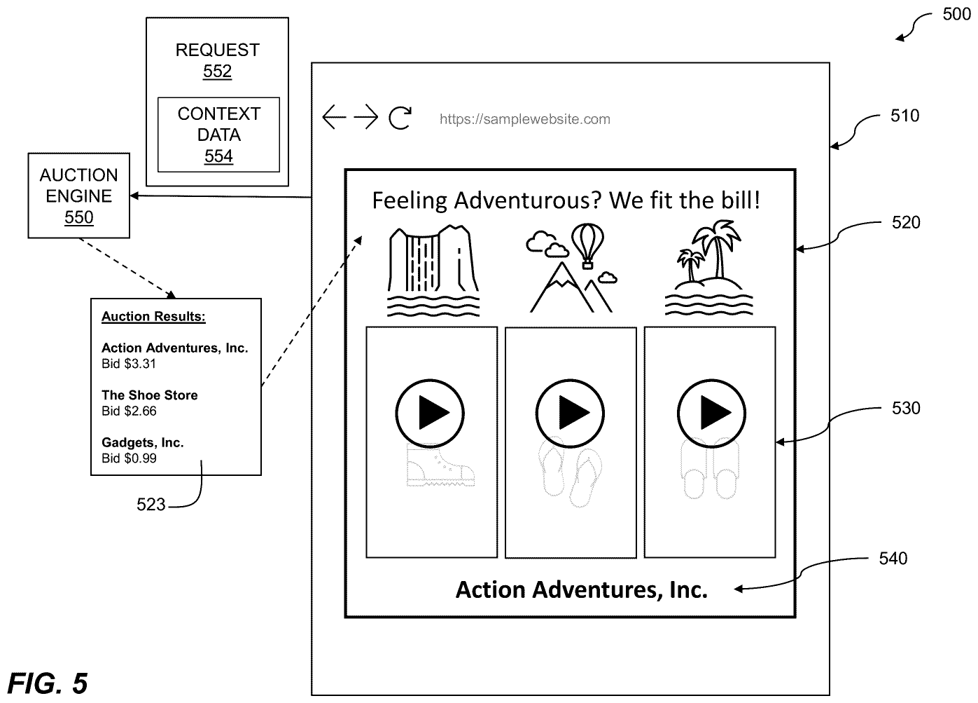

FIG. 5 is an example 500 of an advertisement overlay on a webpage. In the example, a browser 510 renders a website 520. The website 520, upon being invoked, sends a request 552 for a new video segment advertisement to be deployed to the website. The request 552 can contain a bid amount. The bid amount can be in a fiat currency such as USD. In some embodiments, the bid amount can be in a cryptocurrency such as Bitcoin. This request may coincide with requests from other websites getting invoked at or around the same time on other client devices. The other client devices can be smartphones and/or tablet computers from other users. The auction engine 550 may receive a plurality of bids from multiple websites. The auction engine 550 can evaluate the auction bid results 523. In the example 500, there are three bid results, and the highest bidder is Action Adventures, Inc., with a bid amount of $3.31. Therefore, the website 520, which is indicated at 540 as being associated with Action Adventures, Inc., wins the bid, and receives one or more new video segments 530 displayed on the website 520. In some embodiments, the new video segments 530 are displayed using floating video players. In some embodiments, the new video segments are displayed using banner advertisements. In some embodiments, the new video segments are displayed using rich media advertisements. In other embodiments, the new video segments are displayed using video players. In still other embodiments, the new video segments are displayed using container units. One or more new video segments can be selected for display on the website 520. In embodiments, the selecting is based on a bid from an advertiser.

The request 552 can also include context data 554. In embodiments, the context data 554 includes website views, links, advertising history, domain information, user history, conversion rates, or ranking. The conversion rates can include currency conversion rates between two fiat currencies (e.g., conversion rate between USD and Japanese Yen). In some embodiments, when a conversion rate makes products more affordable in a given country, additional new video segments can be populated in websites associated with that country.

As with the example 500, the domain information for website 520 may indicate that the enterprise associated with the domain is Action Adventures, Inc. Metadata associated with the domain information may further include categories such as hiking, swimming, and skiing. The context data can then be used to create and/or select new video segments related to that context. Using the example of footwear, the new video segments can be created for products such as hiking boots, skiing boots, and/or swimming footwear. In this way, website owners can bid to have compelling videos populated on their websites by placing bids. The bids can also serve as an additional revenue source for content creators.

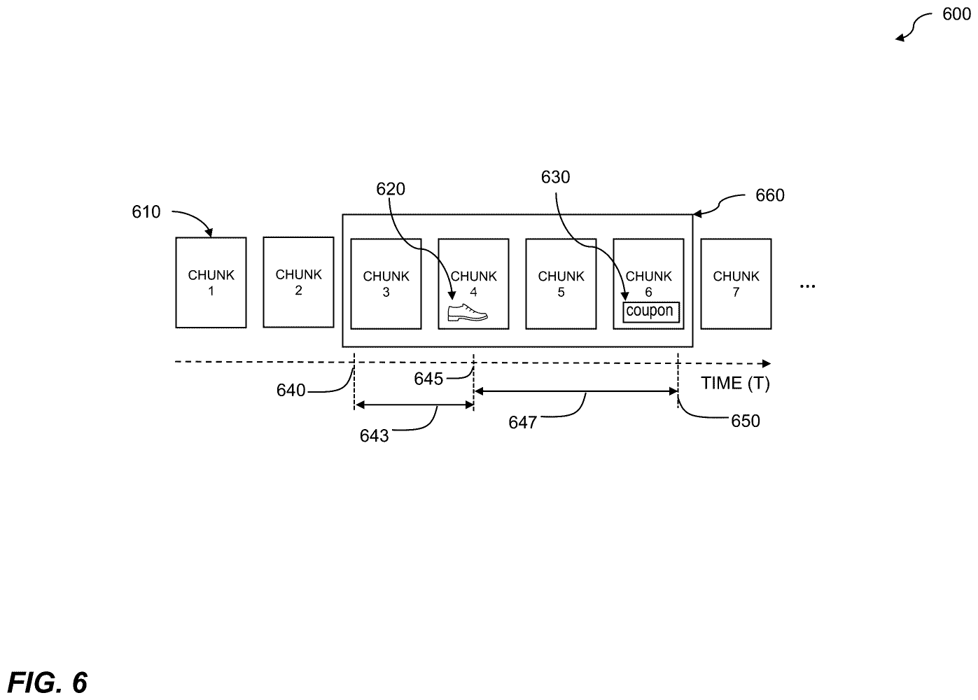

FIG. 6 is an example 600 of editing related short-form videos with specified time intervals from a highlighted image. The example 600 includes multiple chunks of a short-form video, indicated as chunk 1 through chunk 7. The first chunk (chunk 1) is indicated as 610. Each chunk can include one or more sequential video frames. The chunks can be pieces of a continuous video. Thus, the sequence of chunk 1 through chunk 7 can comprise a continuous portion of a short-form video. In embodiments, object recognition is performed on each chunk of video. The object recognition can be based on machine learning algorithms. The machine learning can include the use of image classifiers. In the example 600, an object 620 is identified. The object 620 is a shoe in example 600. The shoe is identified at an identification time indicated at 645. The identification time represents a time at which a product or service is introduced within a short-form video. Embodiments record a timestamp within the short-form video associated with the identification time. In embodiments, the timestamp can be a presentation timestamp for a given frame of video within a chunk in which an object has been identified. The editing engine (366 of FIG. 3) may compute an origin time at a predetermined time preceding the identification time. The origin time is indicated as 640. The editing engine (366 of FIG. 3) may compute a termination time at a predetermined time after the identification time. The termination time is indicated as 650. A first duration 643 defines the amount of time between the origin time 640 and the identification time 645. A second duration 647 defines the amount of time between the identification time 645 and the termination time 650. Duration 643 represents a time before a related product, service, or product category is highlighted in the related short-form video. Duration 647 represents a time after a related product, service, or product category is highlighted in the related short-form video. In embodiments, the time before and time after the related product are different. In embodiments, the editing is based on a specified time before and time after a related product, service, or product category is highlighted in the related short-form video. The chunks and/or frames from the origin time 640 to the termination time 650 comprise a new video segment 660, that can be deployed to various websites by the populating engine (e.g., 454 of FIG. 4).

In embodiments, the related short-form video provides, to a user, a coupon 630 for a product, service, or event. In embodiments, the coupon is an intrinsic part of the new video segment. In some embodiments, the coupon is a promotional code that is uttered by a host individual, and/or displayed as a text overlay over the new video segment. In some embodiments, the coupon includes a QR (quick response) code, barcode, or other optical identifier that can be scanned with an electronic device such as a smartphone or tablet computer. This enables promotional offers to be used to enhance the user experience of disclosed embodiments, and potentially to increase viewer engagement and/or product sales.

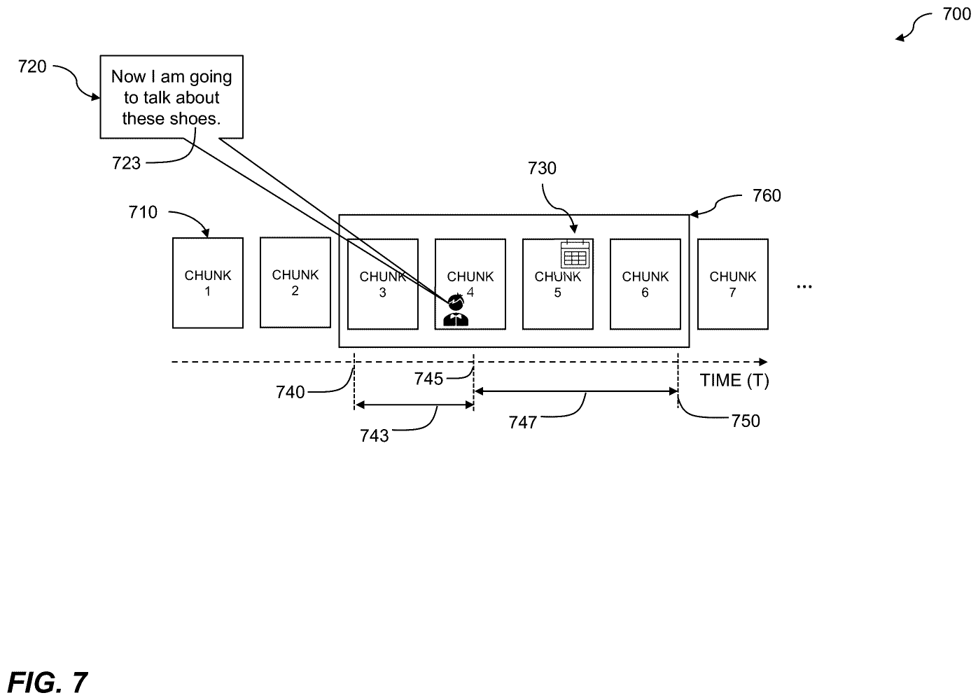

FIG. 7 is an example 700 of editing related short-form videos at specified time intervals with speech recognition. The example 700 includes multiple chunks of a short-form video, indicated as chunk 1 through chunk 7. The first chunk (chunk 1) is indicated as 710. Each chunk can include one or more sequential video frames. The chunks can be pieces of a continuous video. Thus, the sequence of chunk 1 through chunk 7 can comprise a continuous portion of a short-form video. In embodiments, speech recognition is performed on each chunk of video. In the example 700, a speech utterance 720 is recognized. The speech utterance 720 can be from a host individual within the short-form video. The speech utterance 720 can alternatively be from an off-camera individual, a voiceover track, or another audio source from within the short-form video. In embodiments, the speech utterance can be from a livestream. The speech utterance 720 includes a phrase “Now I am going to talk about these shoes.” The word “shoes” 723 is recognized via speech recognition, and/or natural language processing (NLP) techniques, and is associated with an identification time indicated at 745. The identification time represents a time at which a product or service is introduced within a short-form video. Embodiments record a timestamp within the short-form video associated with the identification time. In embodiments, the timestamp can be a presentation timestamp for a given frame of video within a chunk in which an object has been identified. The editing engine (366 of FIG. 3) may compute an origin time at a predetermined time preceding the identification time. In embodiments, the editing is based on speech recognition. The origin time is indicated as 740. The editing engine (366 of FIG. 3) may compute a termination time at a predetermined time after the identification time. The termination time is indicated as 750. A first duration 743 defines the amount of time between the origin time 740 and the identification time 745. A second duration 747 defines the amount of time between the identification time 745 and the termination time 750. Duration 743 represents a time before a related product, service, or product category is highlighted in the related short-form video. Duration 747 represents a time after a related product, service, or product category is highlighted in the related short-form video. In embodiments, the time before and time after the related product are different. In embodiments, the editing is based on a specified time before and time after a related product, service, or product category is highlighted in the related short-form video. The chunks and/or frames from the origin time 740 to the termination time 750 comprise a new video segment 760, that can be deployed to various websites by the populating engine (e.g., 454 of FIG. 4).

In embodiments, the related short-form video provides, to a user, a calendar entry 730 for an upcoming livestream. The calendar entry 730 can include a link to provide access to the livestream. In embodiments, the calendar entry enables users to learn more about the product and/or related products. This enables promotional offers to be used to enhance the user experience of disclosed embodiments, and potentially increase viewer engagement and/or product sales.

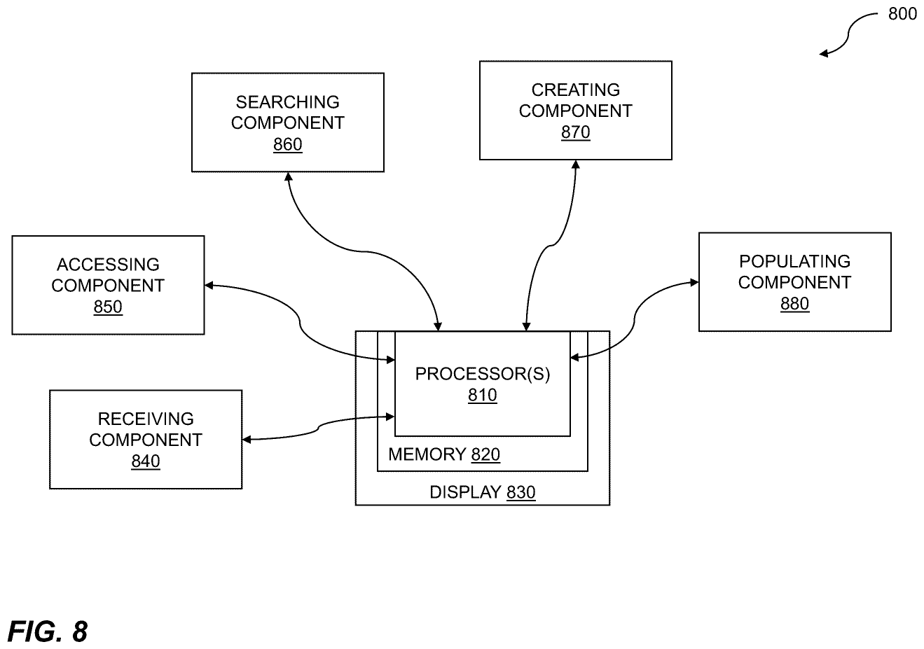

FIG. 8 is a system diagram for creating and populating related short-form video segments. The system 800 can include one or more processors 810 attached to a memory 820 which stores instructions. The system 800 can include a display 830 coupled to the one or more processors 810 for displaying data, video streams, videos, video metadata, product information, auction bid information, editing information, system logs, webpages, intermediate steps, instructions, and so on. In embodiments, one or more processors 810 are attached to the memory 820 where the one or more processors, when executing the instructions which are stored, are configured to: receive, from a website, a request for video content, wherein the request includes context data; access, from a server, a library of short-form videos; search the library of short-form videos for a related short-form video, wherein the search is based on the context data; create a new video segment based on the related short-form video; and populate the new video segment in the website, wherein the populating provides a link to the related short-form video.

The system 800 can include a receiving component 840. The receiving component 840 can include functions and instructions for receiving requests for a new video segment, as well as metadata and/or context data associated with the request. The metadata can include hashtags, repost velocity (e.g., number of reposts per minute for a short-form video on a social media system), user attributes, user history, ranking, product purchase history, view history, and/or user actions. The context data can include user profile information, website views, links, advertising history, domain information, user history, conversion rates, and/or ranking.

The system 800 can include an accessing component 850. The accessing component 850 can include functions and instructions for accessing one or more short-form videos from a short-form video library. The accessing component can utilize various API (application programming interface) functions for obtaining information from a short-form video library.

The system 800 can include a searching component 860. The searching component 860 can include functions and instructions for searching a short-form video library. The functions can include SQL (structured query language) functions for obtaining metadata related to short-form videos. The metadata can include a URL (Uniform Resource Locator) for retrieving and/or streaming a short-form video. The metadata can include other information about the short-form video, including, but not limited to, a title for the short-form video, a date of creation for the short-form video, an indication of whether the short-form video is a livestream, a list of participants featured in the short-form video, a list of products featured in the short-form video, a list of product categories featured in the short-form video, a video resolution for the short-form video, a video format for the short-form video, a duration of the short-form video, a transcript for the short-form video, a list of languages used in the short-form video, an age rating for the short-form video, a geographic location of where the short-form video was filmed, and/or other metadata items. The metadata can be used to search for candidate-related short-form videos that can be used to make new video segments.

The system 800 can include a creating component 870. The creating component 870 can include functions and instructions for creating a new video segment from a short-form video. The new video segment may be an excerpt from a short-form video. The new video segment can include multiple excerpts from a short-form video that are spliced together to form the new video segment. The creating component can insert a transitional effect between excerpts. The transitional effect can include a wipe, a fade, a dissolve, and/or another transitional effect. The creating component 870 can utilize timestamps relating to an identification time, origin time, and termination time to create the new video segment. In some embodiments, the creating component 870 may enforce a maximum duration for the new video segment (e.g., 30 seconds).

The system 800 can include a populating component 880. The populating component 880 can include functions and instructions for populating a new video segment. The populating of a new video segment includes deploying a new video segment to one or more websites in an advertising format. The advertising format can include, but is not limited to, a floating video player, a banner advertisement, a rich media advertisement, a video player, and/or a container unit. The populating component 880 can deploy new video segments based on context data and/or associated metadata. The populating can be used to target a preferred audience. In some embodiments, the populating component 880 can target multiple audiences for the same product. As an example, the populating component 880 can populate a first new video segment for a toy to a website that has an audience primarily comprised of youth or young adults and can populate a second new video segment for a toy to a website that has an audience primarily comprised of parents. The first new video segment can include a demonstration of the toy. The second new video segment can include pricing and/or ordering information for the toy. In this way, disclosed embodiments provide automated, computer-implemented video processing techniques that utilize the ever-growing number of short-form videos for creation of new video segments. The new video segments can be used for product promotion. The new video segments can be placed based on auction bids. Thus, disclosed embodiments enable new features for promotion of products, dissemination of information, and monetization of content.

The system 800 can include a computer program product embodied in a non-transitory computer readable medium for video processing, the computer program product comprising code which causes one or more processors to perform operations of: receiving, from a website, a request for video content, wherein the request includes context data; accessing, from a server, a library of short-form videos; searching the library of short-form videos for a related short-form video, wherein the searching is based on the context data; creating a new video segment based on the related short-form video; and populating the new video segment in the website, wherein the populating provides a link to the related short-form video.

The system 800 can include computer system for video processing, comprising: a memory which stores instructions; one or more processors coupled to the memory wherein the one or more processors, when executing the instructions which are stored, are configured to: receive, from a website, a request for video content, wherein the request includes context data; access, from a server, a library of short-form videos; search the library of short-form videos for a related short-form video, wherein searching is based on the context data; create a new video segment based on the related short-form video; and populate the new video segment in the website, wherein populating provides a link to the related short-form video.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium, and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video processing comprising:
receiving, from a website, a request for video content, wherein the request includes context data;
accessing, from a server, a library of short-form videos;
searching the library of short-form videos for a related short-form video, wherein the searching is based on the context data;
creating a new video segment based on the related short-form video; and
populating the new video segment in the website, wherein the populating provides a link to the related short-form video.

2. The method of claim 1 wherein the populating of the new video segment is accomplished by a floating video player, banner ad, rich media ad format, video player, or container unit.

3. The method of claim 2 wherein the populating the new video segment partially overlays a video playing on the website.

4. The method of claim 2 wherein the new video segment promotes the related short-form video.

5. The method of claim 4 wherein the new video segment is a portion of the related short-form video.

6. The method of claim 5 wherein the new video segment is selected based on an engagement score for a plurality of portions of the related short-form video.

7. The method of claim 4 wherein a second new video segment is simulcast to a second user simultaneously with the new video segment being shown to a first user.

8. The method of claim 1 wherein the related short-form video provides, to a user, a calendar entry for an upcoming livestream.

9. The method of claim 1 wherein the related short-form video provides, to a user, a coupon for a product, service, or event.

10. The method of claim 1 wherein the library includes metadata associated with the related short-form video.

11. The method of claim 1 wherein the library includes advertising information.

12. The method of claim 1 wherein the searching further comprises targeting a preferred audience.

13. The method of claim 12 wherein the targeting is based on celebrity participation in the related short-form video.

14. The method of claim 1 further comprising evaluating the related short-form video.

15. The method of claim 14 wherein the evaluating is based on recommendations, likes, closed-captioned text, or user activity on a social media platform.

16. The method of claim 15 further comprising detecting that a product, service, or product category related to the context data is highlighted in the related short-form video.

17. The method of claim 1 further comprising editing the new video segment.

18. The method of claim 17 wherein the editing is based on a specified time before and time after a related product, service, or product category is highlighted in the related short-form video.

19. The method of claim 18 wherein the time before and time after the related product are different.

20. The method of claim 17 wherein the editing is based on speech recognition.

21. The method of claim 1 further comprising selecting, from a sponsor library, a sponsored overlay.

22. The method of claim 21 wherein the new video segment is rendered on the website within boundaries of the sponsored overlay.

23. The method of claim 21 wherein the selecting is based on a bid from an advertiser.

24. The method of claim 21 wherein the selecting is based on context data.

25. The method of claim 21 wherein the selecting is based on detecting that a product, service, or product category related to the context data is highlighted in the related short-form video.

26. A computer program product embodied in a non-transitory computer readable medium for video processing, the computer program product comprising code which causes one or more processors to perform operations of:
receiving, from a website, a request for video content, wherein the request includes context data;
accessing, from a server, a library of short-form videos;
searching the library of short-form videos for a related short-form video, wherein the searching is based on the context data;
creating a new video segment based on the related short-form video; and
populating the new video segment in the website, wherein the populating provides a link to the related short-form video.

27. A computer system for video processing, comprising:
a memory which stores instructions;
one or more processors coupled to the memory wherein the one or more processors, when executing the instructions which are stored, are configured to:
receive, from a website, a request for video content, wherein the request includes context data;
access, from a server, a library of short-form videos;
search the library of short-form videos for a related short-form video, wherein searching is based on the context data;
create a new video segment based on the related short-form video; and
populate the new video segment in the website, wherein populating provides a link to the related short-form video.
